(19) United States
(12) Patent Application Publication
(10) Pub. No.: US 2009/0219159 A1
(43) Pub. Date: Sep. 3, 2009

(54) METHOD AND SYSTEM FOR AN ELECTRONIC PERSONAL TRAINER

(76) Inventor: Jared Morgenstern, Menlo Park, CA (US)

Correspondence Address: SCHWEGMAN, LUNDBERG & WOESSNER, P.A., P.O. BOX 2938, MINNEAPOLIS, MN, 55402, US

(21) Appl. No.: 12/092,958

(22) PCT Filed: Nov. 7, 2006
(86) PCT No.: PCT/US06/60630

§ 371 Date: Sep. 29, 2008

Related U.S. Application Data
(60) Provisional application No. 60/597,044, filed on Nov. 7, 2005.

(51) Int. Cl. G08B 23/00; H04Q 5/22

(52) U.S. Cl. 340/573.1; 340/10.42

(57) ABSTRACT

A method and system to implement an electronic personal training is provided. According to an example embodiment, personal goals for fitness and health-related activities may be recorded, tracked, and provided, using personal electronic devices. The personal electronic devices may receive and store input from objects (e.g., exercise equipments or food items) in an environment (e.g., a fitness center or a supermarket) and output relevant personal information about the activity currently being input (e.g. on a digital screen, pre-stored version of a human voice, etc.). The portable electronic devices may periodically communicate data with a system located on a communications network, where the fitness data may be processed to provide individual and group reports (e.g. email sent to person, membership trends to gyms, account history available online). A user may set or modify his or her goals by accessing the system via the portable electronic device or a user computer.

### CROSS REFERENCE

This application claims the benefit of U.S. Provisional Application Ser. No. 60/597,044 filed Nov. 7, 2005, which application is incorporated herein by reference.

### TECHNICAL FIELD

This application relates to the fields of personal fitness and health technology. In particular, various example embodiments relate to the capture of health-related information from various environmental objects and conditions.

### BACKGROUND

Physical fitness has increasingly become important to the modern individual Clubs like 24 hour fitness or New York Sports Club operate gyms that offer exercise and coaching to achieve a healthier lifestyle. Personal trainers, experts in health and diet, may be procured at these and similar clubs in order to provide an effective means of coaching individuals to reach a desired health goal. In 2005, one of the gym membership plans at 24 hour fitness in Orange County offered use of the equipment plus a personalized fitness program, 5 personal training sessions, and an electronic device (e.g., BodyGem™) for calculating resting metabolic rate. Increasingly, gyms are becoming more competitive in what they offer customers in order to acquire and maintain memberships. Some memberships offer the ability to work out all the time, others offer more individualized training, others offer a complete set of classes (Yoga, etc.). However, most of the time, personal training services are out of the reach of many fitness seekers, because of the high costs of one-on-one coaching.

Prior art systems do not provide an automated mechanism where individuals can track their diet and/or fitness performance without considerable effort or data entry required on behalf of the individual. Traditional means for managing diets or work outs involve using the trusted pencil and paper technique to record and track progress and diet on a piece of paper. Furthermore, analysis of the pencil and paper reporting technique typically requires the review of a skilled professional or personal trainer and can not be done by the individual.

### BRIEF DESCRIPTION OF THE DRAWINGS

Some example embodiments are illustrated by way of example and not limitation in the figures of the accompanying drawings in which:

FIG. 1 is a flow diagram, illustrating an example embodiment of a high level method for electronic personal training;

FIG. 2 is a flow diagram, illustrating another example embodiment of a high level method for electronic personal training;

FIG. 3 is a flow diagram, illustrating an example embodiment of a high level method for electronic personal training using a portable electronic device;

FIG. 4 is a block diagram, illustrating an example embodiment of a high level block structure of the electronic training system;

FIG. 5 is a block diagram, illustrating an example embodiment of a high level block structure of an input device;

FIG. 6 is flow diagram, illustrating an example embodiment of four possible distribution models and deployment systems for electronic training devices and systems;

FIG. 7 is a flow diagram, illustrating an example operation of a preferred embodiment of the electronic training system;

FIG. 8 is block diagram, illustrating an example daily usage for a person using an electronic training system;

FIG. 9 is a flow chart, depicting in an example embodiment, a high level description of the operation of the environment recognizers;

FIG. 10 is a flow diagram, depicting an example embodiment of the operation of the performance listeners;

FIG. 11 is a collection of four block diagrams, showing four example embodiments of connectivity methods;

FIG. 12 is a collection of flow diagrams, describing in an example embodiment four preferred methods of distribution of electronic training device and other compatible devices;

FIG. 13 is a block diagram, illustrating in an example embodiment how the electronic training system exchange information with the electronic training device or a go-between agents; and

FIG. 14 is a block diagram showing a diagrammatic representation of machine in the example form of a computer system within which a set of instructions, for causing the machine to perform any one or more of the methodologies discussed herein, may be executed

### DETAILED DESCRIPTION

Example methods and systems for an electronic personal trainer are described. In the following description, for purposes of explanation, numerous specific details are set forth in order to provide a thorough understanding of example embodiments. It may be evident, however, to one skilled in the art that the present invention may be practiced without these specific details.

The invention is described herein with reference to detailed illustrative example embodiments. It may be apparent that the invention can be embodied in a wide variety of forms, some of which may be quite different from those of the disclosed example embodiments. Consequently, the specific structural and functional details disclosed herein are merely representative and do not limit the scope of the invention.

Example embodiment is described herein seek to enable a user, amongst other things, to obtain the benefits of a personal trainer without having to pay the expensive costs.

One example embodiment may provide the benefits of a personal trainer to an individual in a monitoring device that may be carried on a user when going to the gym, the supermarket, eating at a restaurant, etc. The monitoring device may work in conjunction with relevant objects in the environment, some of which may be associated with a module or identification device that may enable the monitoring device to more easily recognize the objects. Additionally, the monitoring device may work in conjunction with an Internet system to perform the work a 24-7 personal trainer would provide—tracking, profiling, goal settings, and providing recommendations.

Another example embodiment may provide a digital personal trainer that works by recognizing designated exercise equipment and food, or having a simple means to input unrecognized objects.

A further example embodiment may provide a digital personal trainer that can receive information regarding current activity (e.g. amount of consumption, repetitions/weight) by an individual via data transmission (e.g., radiofrequency transmission), via simplified data entry on the device (e.g., a using a voice interface to receive verbal commands or a data interface to receive text or other data input), or by the exercise machines themselves.

According to a further example embodiment the user may not need to upload and download health related performance data of the user to a communications network. The data may be used for any number of purposes, including but not limited to: aggregate gym club reporting, personalized training program analysis and recommendations emailed to the user, new programs recommended and then installed into the device.

In one example embodiment, there is provided a method for an individual to use a portable device (e.g., Internet-enabled cell phone, Apple's iPod®, etc.) as a monitoring device (and possibly also as a “personal trainer”) to scan barcodes on health related objects (e.g., food and fitness equipment), to recognize the objects, look up user history and goals on an Internet system in relation to the object, and provide health related recommendations to the user.

The user may also input health-related performance into the portable device. In another example embodiment, there is provided a method for a gym to offer services to the customers by including, as part of a membership offering, an electronic personal trainer that can track the performance of a user on the equipment in the gym, as well as exercise and other activities performed outside the gym's boundaries. For example, the portable device may also track the individual's diet and report on both the physical activity and a dietary intake of the user.

In another example embodiment, the portable device may be sold directly to the consumer, as an add-on to their personal music player, such as an iPod®, as a way for customers to track their exercise and diet. Stations at gyms or connections to personal computers may allow the device to upload data to a centralized system for further analysis, the results of which may be provided back to the user via a communication such as a post work-out email.

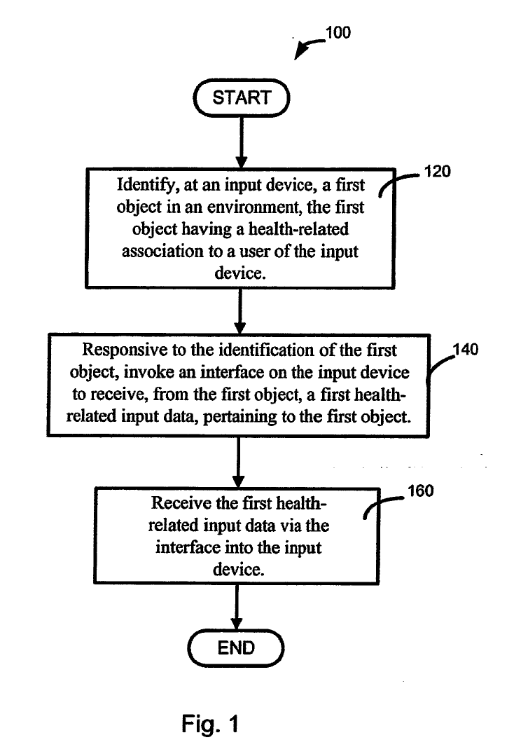

FIG. 1 is a flow chart illustrating an example embodiment of a high level method 100 for electronic personal training. The method 100 starts at operation 120 where the system may identify, at an input device (also referred to as “portable device”), an object in an environment, the object having a health-related association to the user of the input device.

In one example embodiment, the identification of the object may be performed automatically. The automatic identification of the object may include, inter alia, reading a barcode from the first object, comparing an image of the object with multiple images in a related database, reading a Radio Frequency Identification (RFID) tag fixed on the object, receiving optical signal via an optical receiver, wherein, the identification signature is an optical data transmitted from an optical transmitter fixed to the object, and/or receiving an identification related input from a user (e.g., using a data input interface provided by the portable device, or utilizing a voice interface that includes voice recognition technology to recognize a human voice describing the object). In another example embodiment, the identification of the object may be performed responsive to an input from the user. The user, for example, may use the input device to describe an exercise unit in a health-center, a food item in a supermarket, or take a picture of the item and upload it to the system.

The input device itself comprises, or may be a component of, a portable electronic device such as for example: a cell phone, a personal data assistant (PDA), or an iPod®, etc. The object may be an exercise unit (also referred to as “exercise equipment”) or a food item; and the environment may include the fitness facility where exercise units are provided; a supermarket, where the user may be shopping some food items; or a restaurant where the user is having a meal.

Following the identification of the object, at operation 140, the system may invoke an interface on the input device to receive, from the object, health-related input data pertaining to the object. Then, at operation 160, the health-related input data may be received, via the interface, into the input device.

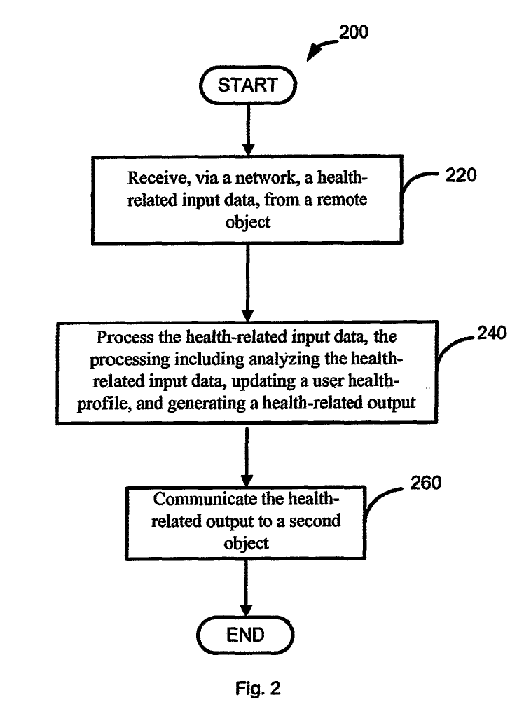

In one example embodiment, an interface may include a wireless radio frequency (RF) transceiver, or an optical transceiver; the health-related input data pertaining to the object may include the user's performance on an exercise unit, or the description of the exercise unit. The method 100 continues with the operations of FIG. 2 described below.

FIG. 2 is a flow chart illustrating a further example embodiment of a high level method 200 for electronic personal training. The method 200 may follow the operation 160 of FIG. 1. At operation 220, the system may receive, via a network, the health-related input data, from a remote object. In one example embodiment, the remote object may be the input device, a user interface, and an agent server connected via the environment's internal network to a plurality of exercise units in the environment.

The health-related input data may then be processed at operation 240. The processing may include analyzing the health-related input data (e.g., to identify the source of the input data what information the source carries and what the system needs to do with it), updating a user health-related profile, and generating a health-related output.

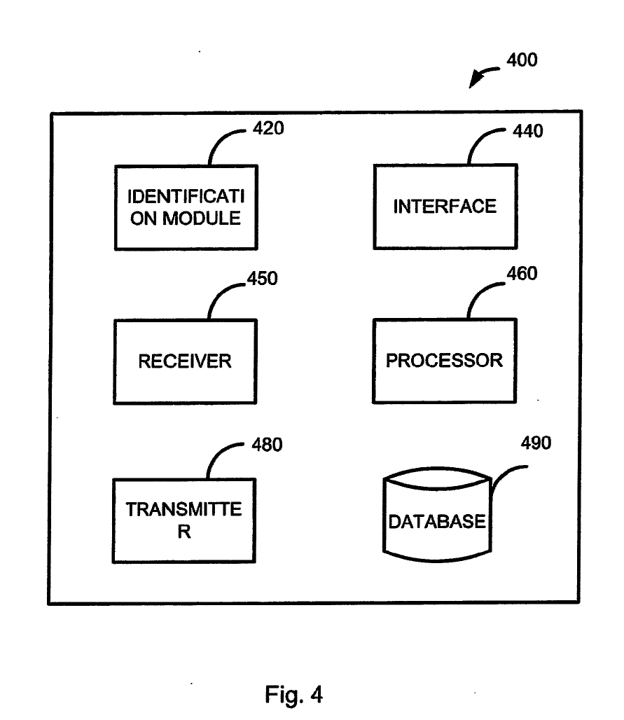

In one example embodiment, the user health-profile may include a health-profile already existing on the system database 490 (see FIG. 4) describing the user's general health related information including, health related objectives, any diet or exercise program, and past performances on various exercise units, etc. The health-related output data may include, inter alia, a plurality of instructions to an exercise unit to modify settings of the exercise unit in accordance with the health-objectives and past performance of the user, the performance report of the user on an exercise unit, and the dietary intake of the user.

The output report may then be communicated to a second object (operation 260). In one example embodiment, the second object may include an exercise unit (e.g., a step machine, a sit-up station, or a bench press), the input device (e.g., a cell phone, a PDA or an iPod), a user computer, and an agent server connected via an internal network of the environment to a plurality of exercise units in the environment (e.g., fitness center).

In one example embodiment, there is provided a method for an individual to use an input device such as an Internet enabled cell phone as a personal trainer. According to an example embodiment, the input device may be acquired through purchase form a vendor; purchase from the environment (e.g., a fitness center); or as loaner device loaned from the environment. The device may furthermore be operable to identify the user after receiving the user's identification. An example method for using the input device as a personal trainer is described below.

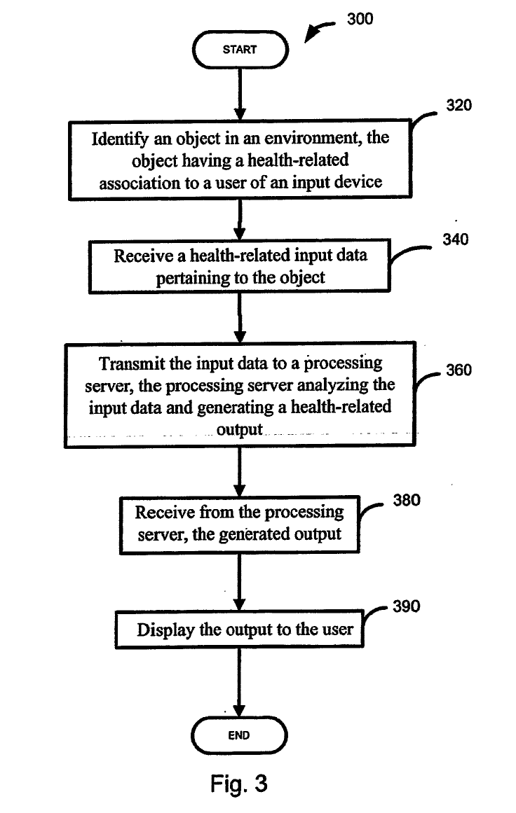

FIG. 3 is a flow chart illustrating a method 300, according to an example embodiment, for electronic personal training using a portable electronic device. At operation 320, the input device may identify a first object, at an input device, in an environment, the first object having a health-related association to a user of the input device.

In one example embodiment, the identification of the object may be performed automatically. The automatic identification of the object may include reading a barcode associated with (e.g., printed on or otherwise attached to) the first object and communicating the barcode data to the processing server; capturing an image of the object and transmitting the image to the processing server and recognizing the object at the processing server by comparing the image of the object with an image in a related database; reading an RFID tag associated with (e.g., attached to) the object and communicating the tag data to the processing server; receiving an identity related input from a user and communicating the input to the processing server; and/or recording a human voice describing the object, communicating the recorded voice to the processing server and using voice recognition technology to extract and compile identification information, identifying the object, from the human voice.

In another example embodiment, the identification of the object may be performed responsive to an input from the user. The user, for example, may use the input device to describe an exercise unit in a health-center, a food item in supermarket, or take a picture of the item and upload it to the system.

In one example embodiment, the input device may include a portable electronic device such as: a cell phone, a personal data assistant (PDA), or an iPod®, etc. The object may be an exercise unit or a food item; and the environment may be a fitness facility where exercise units are provided; the supermarket, whereat the user may be shopping some food items; or the restaurant where the user is having a meal.

Following the identification of the first object, the health-related input data pertaining to the object is received at the input device (operation 340). In one example embodiment, the health-related input data pertaining to the object may include data regarding the user's performance on an exercise unit, or a description of the exercise unit, or the nutrient content of the food item (e.g. a packaged food from a supermarket, or a meal served at a restaurant).

In one example embodiment, the input device may receive the health related input data via any one or more of a number of methods including: wireless RF communication between the input device and an exercise unit; recording a human voice reading the data into the input device; receiving the data from a user interface in the input device; and optical communication between the input device and an exercise unit.

At operation 360, the input data may be transmitted, via a network, to a processing server, and the processing server may analyze the input data and generate a health-related output data.

In one example embodiment, the transmission may be through a wireless RF communication from the input device to the server; the analysis of the input data may include identification of the data source, what information the data source carries and what operations the system needs to perform with the data.

In one example embodiment, the health-related output data may include health related performance report of the user on one or more exercise units; a set of health related instruction for the user to follow; the dietary intake of the user; and a dietary recommendation to the user.

The generated output is then received, at the input device, from the processing server (operation 380) and displayed to the user (operation 390) visually or played as a human like voice, via a voice synthesizer technology. In other words, either a visual interface or an audio interface may be used to present the generated output to the user.

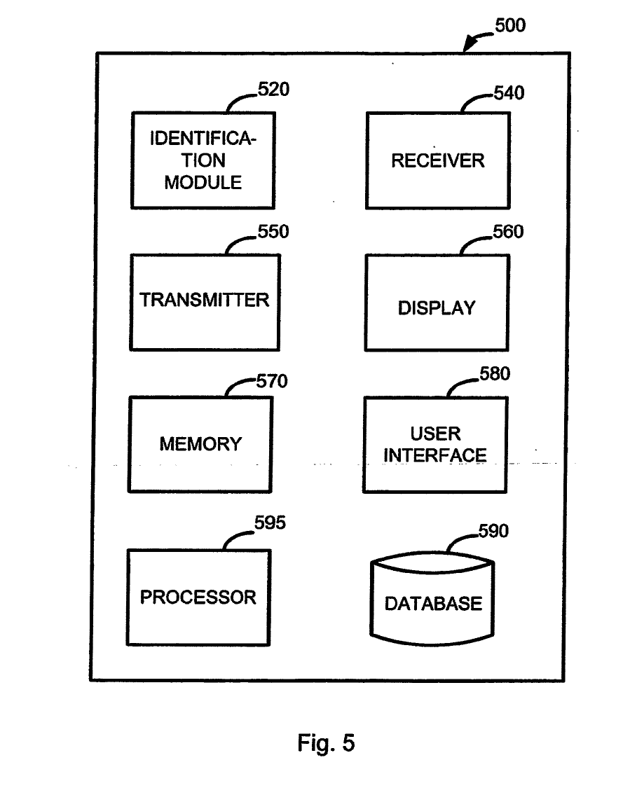

In the following sections the electronic personal training system is viewed and discussed from two different angles. In the first representation, shown in FIG. 4, a high level description of the system from a user's point of view is discussed, where the system includes the electronic trainer server, and the electronic portable device. Whereas in the second representation shown in FIG. 5, only the electronic portable device (also referred to as “electronic input device”) is discussed.

FIG. 4 is a block diagram illustrating architecture, according to an example embodiment, for an electronic training system. The example system 400 may include an identification module 420, an interface module 440, a receiver module 450, a processor module 460, a transmitter module 480 and a system database 490.

The identification module 420 may identify, at the input device 500 (see FIG. 5) an object, having a health-related association to a user of the input device, in a particular environment. The environment may automatically be detected by the input device 500 (e.g., a gym environment in which the user is exercising) or may be specified by the user where multiple environments are present.

According to an example embodiment, the identification of the object may be performed automatically. The module 420 may use an identification label fixed to (or otherwise associated with) the object to determine an object's identity. The identification module 420 may include a barcode reader, which can read a barcode fixed to the object. The identification module 420 may further include a digital camera to capture an image of the object and also include an object recognizer (not shown) to recognize the object by comparing the captured image of the object with a stored image from a collection of images in a database 490. The identification module 420 may further include a RFID tag reader to read a RFID tag associated with the object. Such RFID tags are typically readable by illuminating them with a reading RF signal from an RFID reader device. The reader then decodes the received signal in order to recover the object's signature from the received RF signal. The passive RFID tags may also receive their power from the reader RF pulses directed at them.

In another example embodiment, the identification of the object may be performed responsive to an input from the user. The user, for example, may use the input device to describe an exercise unit in a health-center, a food item in a supermarket, or take a picture of the item and upload it to the system.

In an example embodiment, the identification module 420 may include an optical receiver to receive an optical signature from an optical emitter associated with the object (e.g., an infra red (IR) detector receiving IR signals from an IR emitter).

In yet another example embodiment, the identification module 420 may include a voice recorder to record a human voice describing the object and a voice recognizer to recognize the human voice and derive the description of the object from the recorded voice.

In an example embodiment, the object may be an exercise unit in a fitness center, a personal exercise unit, or a food item carrying any of the identification labeling described above. The food item may include a packaged food item typically available at supermarkets, a meal served at a restaurant, or even a fitness-related medication.

The interface module 440, in response to the identification of the object by the identification module 420, may receive a health-related input data into the input device 500 (see FIG. 5) described below. According to an example embodiment, the health-related input data may include the user's performance on an exercise unit a description of the exercise unit, or a nutrient content of a food item (e.g. a packaged food from a supermarket, or a meal served at a restaurant or a fitness related medication).

The receiver module 450 may receive, via a network, a personal health-related input data, from a remote object. In an example embodiment, the personal health-related input data may include health-related activity, health-related history, and health-related objectives of the user.

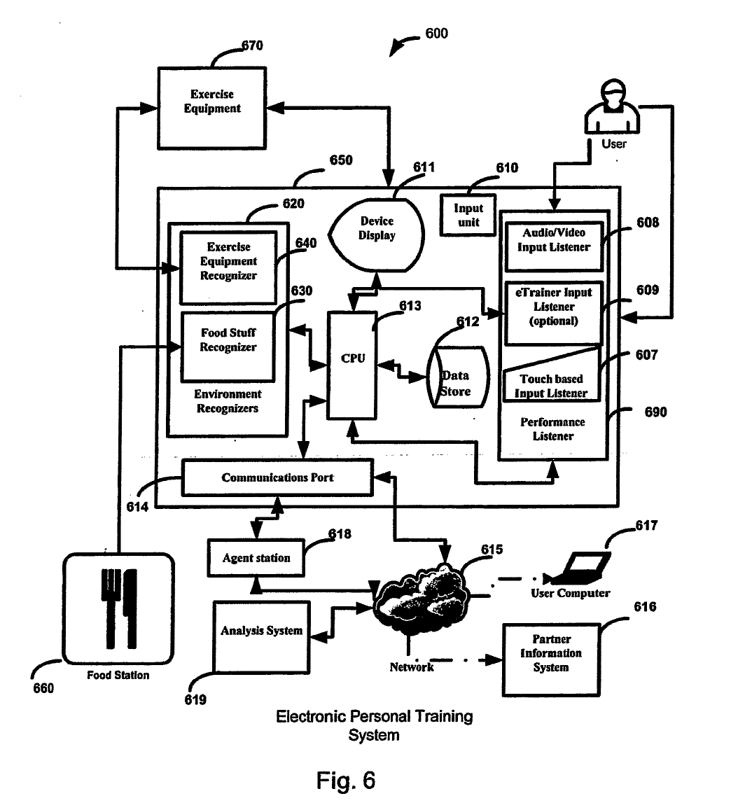

According to one example embodiment, the remote object may be an exercise unit (e.g., a personal exercise unit or one at a fitness center) the input device 500 (see FIG. 5), a user computer 617 (see FIG. 6), and an agent station 618 (also referred to as “connection point”) (see FIG. 6), connected via the internal network of the environment to a plurality of exercise equipments 670 (see FIG. 6), in the environment (e.g. fitness center).

The processor module 460 may process the health-related input data. The processing may include analyzing the health-related input data, updating the user's health-profile, and generating a health-related output report.

The transmitter module 480 may communicate the health-related output report to a second object. According to one example embodiment, the health-related output report may include a performance report relating to a user's performance on an exercise unit, and a dietary intake of the user. In another example embodiment, the health-related output may include instructions to an exercise unit, the instructions to modify settings of the exercise unit in accordance with the health-objectives and past performance of the user.

In one example embodiment, the second object may be exercise equipment 670 (see FIG. 6), the input device 500 (see FIG. 5), a user computer 617 (see FIG. 6), and an agent station 618 ((see FIG. 6), connected via an internal network of the environment to multiple exercise equipments 670 in the environment.

The database 490 may store various health related information, including the health-profile of the user, the user's past performances and dietary data. In one example embodiment, the database 490 may include general and technical specifications of various pieces of exercise equipment available at a fitness facility or otherwise accessible to the user. The database 490 may also include nutrition and ingredient data of a plurality of food items or fitness related medications. The database 490 may include a variety of health related documents such as: articles, brochures, manuals or instructions provided by the electronic training system or uploaded into the system by a fitness facility or a user.

FIG. 5 is a block diagram illustrating a high level architecture, according to an example embodiment, of an input device 500. The input device 500 may include an identification module 520, a receiver module 540, a transmitter module 550, a display module 560, a memory module 570, a user interface module 580, a database 590, and a processor 595.

The identification module 520 may identify an object, having a health-related association to a user of the input device 500, in an environment in which the input device 500 is operating, or in a further environment selected by user.

In one example embodiment, the identification of the object by the identification module 520 may be performed automatically. In another example embodiment, the identification of the object may be performed responsive to an input from the user. The user, for example, may use the user interface 580 to describe an exercise unit in a health-center, a food item in a supermarket, or take a picture of the item; which the receiver module 540 may capture and deliver to the processor module 595 or the transmitter 550. The processor 595 may partially or entirely process the data received from the receiver and send the result to the display module 560 for displaying to the user. The transmitter 550 may transmit the received data from the receiver to the processor 460 (FIG. 4).

According to an example embodiment, the identification module 520 may use an identification label fixed to the object to read the object's identification. The identification module 520 may include a barcode reader which can read a barcode fixed to the object. The identification module 520 may include a digital camera to capture an image of the object and also include an object recognizer to recognize the object by comparing the captured image of the object with a stored image from a collection of images in a database 490. The identification module 520 may also include a RFID tag reader to read a RFID tag associated with the object, such RFID tags are typically readable by illuminating them with a reading RF signal from an RFID reader device. The reader may have to decode the received signal in order to recover the object's signature from the received RF signal. The passive RFID tags are also available which receive their power from the reader RF pulses directed to the tags.

The identification module 520 may include an optical receiver to receive an optical signature from an optical emitter associated with the object (e.g., an infra red (IR) detector receiving IR signals from an IR emitter).

The identification module 520 may also include a voice recorder, recording a human voice describing the object and a voice recognizer to recognize the human voice and derive the description of the object from the recorded voice.

The object may be an exercise unit in a fitness center, a personal exercise unit, or a food item carrying any of the identification labeling described above. The food item may be a packaged food item typically available at supermarkets, a meal served at a restaurant, or even a fitness-related medication.

According to an example embodiment, the environment may be a fitness center, a supermarket, or a restaurant.

The receiver module 540 receives, from the identified object, a health-related input data associated with a user. According to one example embodiment, the health-related input may include a description of the exercise unit, a report of user's activities and performance on that unit.

The user may want to enter some inputs, via the user interface module 580 of the input device. According to an example embodiment, such inputs may include a description of an exercise unit at home or at a fitness center, the description of a food item or any other dietary intake, or the user's health-related objectives, health-related activities, and health-related performances.

The transmitter module 550 may transmit, via a network, the health-related input data to the processor module 460 (FIG. 4) (also referred to as “processing server”) to analyze the input data (e.g., to find out where the source of the data is, what information it carries and what the system 400 needs to do with it).

The processor 460 may update a user health-related profile, generate one or more health-related outputs (operation 240), and communicate the outputs to the input device 500 where it may be received by the receiver module 540 and delivered to the display module 560.

In an example embodiment, the display module 560 may provide a visual (e.g., text or graphical) output to the user. In an alternative example embodiment, the display module 560 may use a voice synthesizer to generate a voice and play that voice as a way of presenting the output to the user.

The input device 500 may use the memory module 570 as buffer to store some temporary data before communicating the data to the system 400 or an agent station 618 (see FIG. 6). The input device 500 may also use a database 590 to retrieve some health related information associated with the user or some exercise units. In an example embodiment, the database 590 may contain user's health related history or performance. The database 590 may also contain dietary information, or data regarding ingredients or nutrients content of some food items or fitness related medications.

In an example embodiment, the input device 500 may use the processor 595 to perform necessary processing on the input data received from the user interface module 580 or the identification module 520, without having to communicate with the processor module 460 (FIG. 4). For example, using the processor 595, the input device 500 may be able to compare an image of an object captured by the identification module 520 with an image in the database 590 to reach a conclusion regarding the identity of that object.

In an example embodiment, the input device 500 may be an attachment to a second device (e.g. an iPod®) acting as a peripheral of that device. The device may include one or all of a digital camera, a bar code scanner or a RFID reader to facilitate identification of various objects. This device may communicate the input data received from the bar code scan or a picture of the bar code to software residing on the second device (e.g., iPod®). The software residing on the second device may take the input from the peripheral (using OCR (optical code recognition) to obtain the barcode from the picture of the barcode, or using the bar code scanning or RFID technology) and try to recognize the object from the input, and use the second device screen to present a goal suggestion based on some profile data that it has on the past performance and goals of the user. Later on, when the user synch up the second device (e.g. iPod®) with the server or place it in the Dock Connector, it may communicate with an agent on the user computer (e.g., iTunes®), which then may communicate the data to a server system, to update the performance and progress of the user and download new goals, firmware, etc.

In another example embodiment, the input device 500 may be a wristwatch that may contain health-related measuring and monitoring capabilities (such as pedometry and heart rate monitoring), that can also read bar codes (e.g. equipped with a digital camera and an OCR, a bar code reader, or a RFID chip) that has the processing unit on the device to look up past performance and suggest objectives in it's own interface. The device may have a USB. (universal Serial Bus) connection or some other type of connection that allows it to communicate with an agent on the user computer that may communicate with the server system.

In another example embodiment, a combination of the above two embodiments may be deployed, where some of the processing is performed by the input device 500 and the rest by a software existing in the second device (e.g. iPod).

In another example embodiment, the input device 500 may be a digital camera that is equipped with an RFID reader or bar code scanning technology and also has a processing unit on the device. Processing software may be downloaded to the input device 500 to render it capable of performing object identification and other needed tasks.

FIG. 6 is a block diagram illustrating components, according to an example embodiment, of an electronic personal training system 600 (hereinafter referred to as “electronic training system”). The electronic training system 600 may include a portable device 650. The portable device 650 may include, at least one communications port 614, a central processing unit (CPU) 613, the database 612, the device, input unit 610, a device display 611, the environment recognizer module 620, a performance listener module 690, and one or more input performance listener sub-modules (e.g., 607-609).

The communications port 614 is communicatively coupled (e.g., through a wide or wireless connection) to an agent station 618 in an environment (e.g., a fitness facility etc.) or directly via a network 615. In one example embodiment, the communications port 614 may include multiple technologies for two way communications, such as GPRS (General Packet Radio Service) mobile phone standards, or shorter range Bluetooth, for example. In another example embodiment, the communications port 614 may include interfaces such as 80211b, USB (Universal Serial Bus), Fire wire, etc. According to one example embodiment, the input unit 610 may contain at least a keyboard or a button system for typed input and an infrared device capable of reading barcodes. In another example embodiment, the input unit 610 may also contain a microphone for audio recording and a camera for video for image recording (such as the ones available in camera phones), or a barcode reader for scanning items with barcode labels. The infrared scanning device may be programmed to read inputs other than barcodes for identification purposes. The communications port 614 may also include an RFID interface for radiofrequency communications with RFID tags.

The CPU 613 may control the communication technologies and the input unit modules with software designed to emulate a digital personal trainer.

The database 612 may contain pre-existing relevant data (e.g., apple has about 100 calories, bench press has such characteristics, etc.) and performance accepting schemas (e.g., how many bites, weight/count/reps, respectively). In an alternative embodiment, the device 650 is able to communicate directly with a larger database, via the Internet (through a cell phone, for example). In either embodiment, the device 650 may ultimately access a UPC (Universal Product Code) database and/or object database for use in identifying the objects in the environment (e.g., via barcodes or RFID codes, both for food identification and for fitness machine identification).

The software in the electronic training device 650 may conceptually be broken down into an environment recognizer module 620 (ERM) and a performance listener module 690 (PLM).

The environment recognizer module 620 may be used to learn of objects in the environment that are of importance to personal health management, and that would be important to a real personal trainer, such as fitness machines or food items. As such, the environment recognizer module 620 may include an exercise equipment recognizer 640, which may communicate with exercise equipment 670; and a food stuff recognizer 630, receiving inputs from a food station 660 (also referred to as “food connection point”). In an example embodiment using a device (e.g. cell phone) equipped with a barcode reader, the receipt of the input may be accomplished by scanning food labels and labels on fitness machines, and passing the read UPC codes to an software analysis system 619 (e.g., accessible through electronic training website, via a web browser, along with user account information, or via the network 615).

The performance listener module 690 contains t sub-modules to enable the device 650 to ascertain and activity that was performed. For example, the environment recognizer module 620 may determine that the user is at a treadmill machine, while the performance listener module 690 would obtain the information that the user ran for 30 minutes at a heart rate of 157 and burned 467 calories, etc. The sub-modules of performance listener module 690, in an example embodiment, may include an audio/video input listener 608, electronic training input listener 609, and a touch based input listener 607.

The audio/video input listener 608 may accept auditory and visual inputs. An electronic training input listener may listen for electronic training language output from exercise equipment 670 (e.g. a workout machine) that can report (via a Bluetooth for example) to the electronic training how the user performed.

Another sub-module of performance listener module 690 is a touch based input listener 607. The listener 607 may be used by users to type in performance data. All these sub-modules (607-609) may appear to restrict the input space based on a predetermined relevant schema (e.g., the fitness or food world and the object that the environment recognizer module 620 has reported); however this may not be necessary. In an example embodiment in which the portable device is a barcode reading cell phone, the performance listener module 690 may also take the form of a keyboard input passed to an software analysis system 619 (via the internet connection of a mobile web browser, for example) or vocal input passed to an software analysis system 619 (via Internet connection of a mobile web browser that is enabled to understand audio input).

As mentioned above, in an example embodiment, the device 650 illustrated in FIG. 6 may be a cell phone with a barcode reader enhancement and Internet access via a mobile phone protocol. In another example embodiment, it may be an iPod with a barcode reader enhancement and no Internet access. In yet another example embodiment, it may be a barcode reading and Bluetooth enabled device.

Also shown in FIG. 6 is a food station 660. The food station 660, which might be deployed in a health food supermarket, enables shoppers to enter their shopping carts into the electronic training system and receive reports (operation 1117) and advice based on their customized training program while still in the store. The supermarket may optionally receive information on the diets of their customers using such a system. The food station 660 may allow the user to connect the electronic training device 650 to a personal computer 617 to upload the electronic training data to the software analysis system 619 for immediate feedback, customization of programming, and other options.

FIG. 6 also shows a networked system that operates outside of the electronic training device 650, including an agent station 618 that may be used by the electronic training device 650 to communicate with the software analysis system 619 (e.g., a Bluetooth kiosk in a gym uploading data to the user's account on electronic training's website). In the example embodiment of a barcode cell phone, this agent station 618 may not be necessary; the data may be transmitted directly to the software analysis system 619 or electronic training website.

The user may also reach the software analysis system 619 without the agent in another way, for example, by coupling the device to their compatible personal computer (user computer 617). Also shown in FIG. 6 is the partner information system 616, which may enable partners (such as gyms or restaurant partners, for example), to access some information regarding the device usage of their customers. Of course, enabling partners to access information regarding device 650 usage requires deployment sufficient safety measures to protect the privacy of the relevant user of the device 650. Such safety measures may include, for example, restricting access by partners to limited data.

In order for a fitness-related object in the environment to be identified, it may be required that the gym owners outfit their machines and stations with barcodes or other identification indicia. Furthermore, retailers or producers are of food items may be encouraged to tag the nutritional value of meals and packaged foods using barcodes. In this way, an electronic training device 650 is enabled to quickly input object data. If UPCs are unusable or not supplied to certain fitness related objects, the electronic training system may provide a proprietary or dedicated coding scheme and object database, to be used in conjunction with a UPC database, to ensure identification of objects.

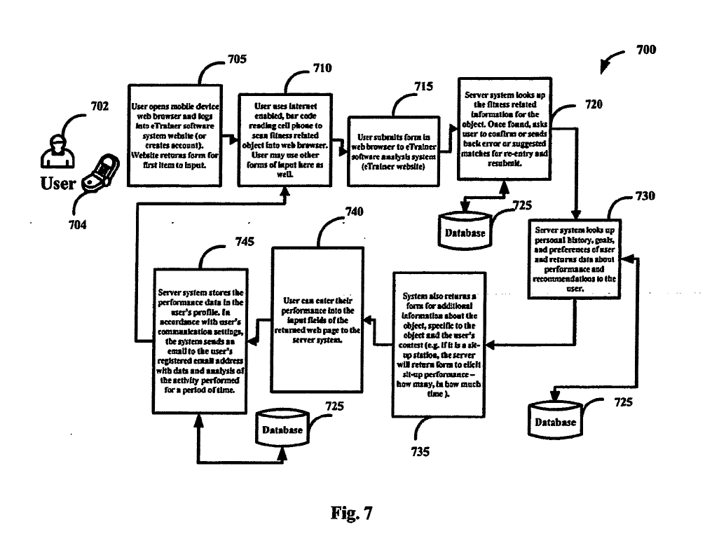

FIG. 7 is a flow chart illustrating a method 700, according to an example embodiment, of operation of the electronic training system 600. In this flow chart, the user 702 is equipped with an Internet enabled cell phone 704 that may be operationally equipped with a barcode reader. This cell phone 704 may represent and work as the electronic training device 650 and may be able to identify health related objects (such as 660 and 670), in this example embodiment.

In example embodiment, the user opens the web browser in their Internet enabled cell phone 704 and navigates to the electronic training system 600 website. The site may prompt the user to login to the system (or create an account if this is the user's first time on the site). Once logged in, the software system web site may return a form to the cell phone web browser that may ask for the object to be input (operation 705). The user may then, at operation 710, choose how to input the device (e.g., touch based keypad input, barcode scan, or any of the other enabled options such as voice recognition).

After the web browser form has the input, the user may, at operation 715, submit it to the website where it is matched against a database 725 to find a match. If no match is found, the electronic training system 600 may return a form or page that allows the user to try again or select from a few matching items. If a match is found, the item may be returned to the user for verification (operation 720).

Once an item is verified, at operation 730, the software system may look up the user's profile, including past performance, plans, and goals, and send back relevant information and recommendations to the user 702, along with a form for follow-up information to be collected about the item, specific to that item (operation 735). For example, if the item is a nutrition bar, the electronic training system 600 may return a form that asks how much was eaten. If the item was a bench press machine 830, the item may return a form pre-populated with previous performance with respect to weight, repetitions, etc. (operation 735).

The electronic training system 600 may then, at operation 745, store the performance data on the user profile at database 725 and send an email to the user's registered email address with data and analysis of the activity performed for a period of time.

At this point, the user 702 may submit a follow-up or continue as long as there are new objects to be recognized. The user 702 may also access the account via a personal computer web page, to set up user's preferences, goals, etc., and view reports. The user can also specify contact settings, including how often they wish to receive an email with performance analysis and recommendations (such as for example—after every workout, every day, every week, etc.).

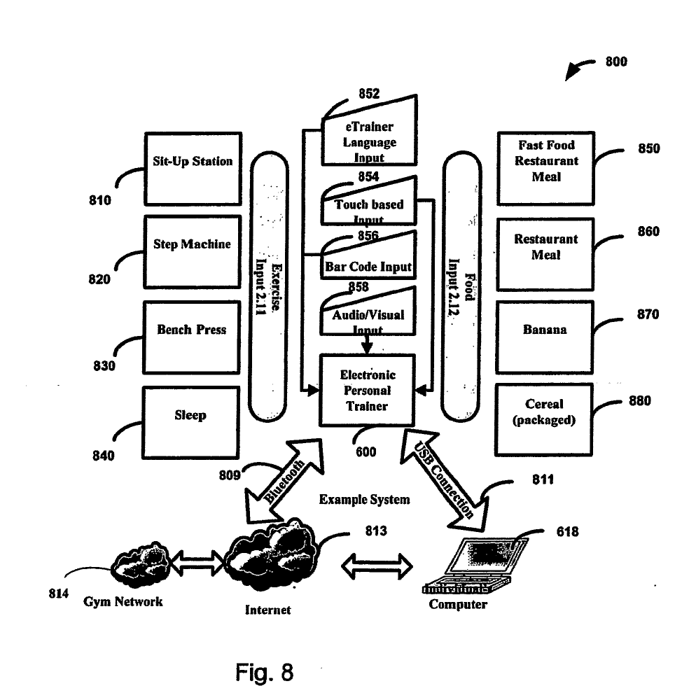

FIG. 8 is block diagram 800, illustrating an example daily usage for a person using an electronic training system 600. On the left side of the diagram there are various physical activities performed by the user 702: sit-up station 810, step machine 820, bench press 830, and sleep 840. All of these activities have a corresponding effect on physical well being and can be tracked in the user's personal training plan by the electronic training system 600.

On the right of the block diagram, various food intakes are. The example food intakes may include fast food meal 850, non fast food restaurant meal 860, banana 870, and cereal 880. All of these items have an affect on nutrition and diet and can be tracked in the user's personal training plan by the electronic training system 600. The appropriate or user-chosen method of input to the ERM 740 may be used to identify the items. For example, the user 702 may speak “banana” (or with an upgraded device, take a photo of it), wave the electronic training device 650 next to the step machine 820, scan a barcode on the bench press 830, select sit-up station 810 after navigating several menus on the electronic training device display 611, scan a barcode on the receipt of a fast food meal 850, type in the calories of foods associated with a restaurant meal 860, and scan in the UPC code on the serial box 880.

The environment recognizer module 620 may use one or a combination of the following (as the previous example demonstrated) to recognize the objects in the environment: electronic training language input to the electronic training input listener 609 (e.g., wave next to step machine 820—for example implemented using Bluetooth 809), touch based input 607 (e.g., browse for sit-up station 810), barcode input (e.g., part of input unit 610) (cereal 880 UPC), and audio/visual input to audio/video listener 608 (banana 870). The electronic training device 650 then can communicate directly with the software analysis system 619 in one example embodiment, with a gym network 814, in another example embodiment, or in yet another example embodiment, the user computer 617 in order to have the data sent to the software analysis system 619 for reporting. A user computer 617 may connect to the electronic training system 600 via the USB connection 811.

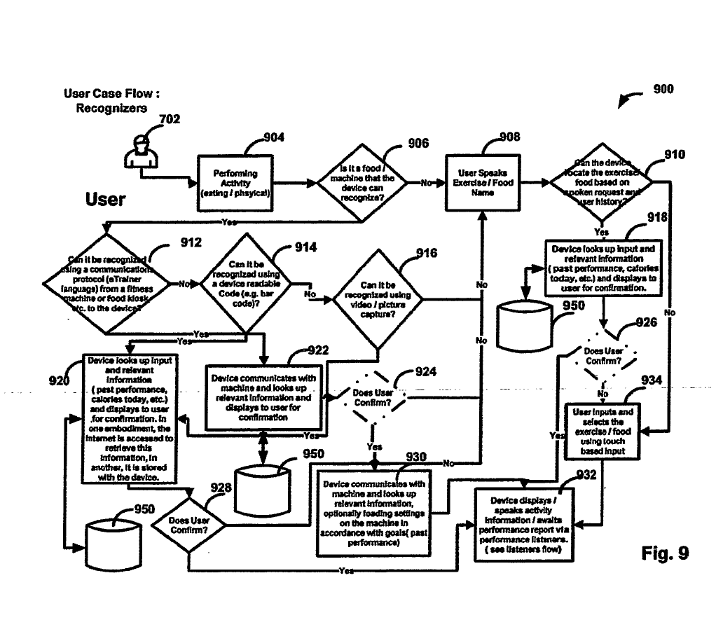

FIG. 9 is a flow chart illustrating a method 900, according to an example embodiment, of operation of the environment recognizer module 620. When the user 702 is performing an activity (operation 904) that the device 650 can recognize (checked at operation 906), the user 702 has several options (decision operations 912, 914, and 916 decides about these options).

If the device 650 detects electronic training language output (decision operation 912), it may attempt at operation 922 to communicate directly with the object to identify the object. The device 650 may ask the user 702 to confirm this identification of the relevant object (decision operation 924). If the user 702 confirms, the object has been recognized (see operation 930). If the user 702 did not confirm, control may be passed to operation 908. If at decision operation 912 the device 650 could not suggest any objects, the user 702 may at operation 914 determine whether the object is tagged with a barcode. If so, the user 702 may scan the barcode. At this point, the electronic training device 650 may look up the item, at operation 920, based on the barcode and report the item that it has found or that it has not found anything. If the device 650 is able to identify the object, the user 702 may be asked to confirm (decision operation 928). If the user 702 confirms, the object has been recognized (see operation 932). If the user 702 did not confirm, then control may be passed to operation 908. If at operation 914, the device could not suggest any object, or if there was no barcode associated with the object, the user 702 may try to see whether using a visual input may work to identify the object. For example, the device 650 may be used to take picture with the device (operation 916). If the visual input successful, the control may be passed to operation 920 described before. If the visual input was unsuccessful, the system may continue to operation 908. At this operation the user may speak the exercise/food name, and in this way provide identification input to the device 650.

If the electronic training device has identified an object, the device 650, at operation 918, may look up input and relevant information (e.g., past performance, calories, etc.) and display this information to the user for confirmation. The user 702 may be asked to confirm (decision operations 926). If the user 702 confirms, the object has been recognized (see operation 932). If the user 702 does not confirm or the device could not suggest any object, the user 702 may input object identification information using the touch based input listener 607, for example by selecting the device from a hierarchical series of sub-menus or typing the item (operation 934). If at decision operation 926 the user confirmed, the system continues to operation 930.

All identification logic may be enhanced with the knowledge of the history of the user 702 and limited to a view of world objects that only include fitness related objects, reducing the number of items necessary for storage in the device (see operation 918).

After the object has been recognized, a display for that type of object may be shown on the device 650 or otherwise communicated to the user 702 (read by a pre-recorded voice, for example). An item recognized as food may have a display presenting the last time that this item was eaten, its calories, whether or not it is a good choice for eating now, based on a selected diet, etc. An item recognized as an exercise may show past performance and what is required this time to meet goal progress.

The user 702 may of course skip some of the operations of recognition and try others—there is no implicit required order. The method 900 does not require the user 702 must try each option before moving on to the next.

The electronic training device 650 may also report some suggestions or fuzzy matching if it is not able to exactly identify the object to be recognized based on the provide input. For example, the device 650 may allow the user 702 to select from a number of possible items (for example, if the user 702 mumbles sit-up and the device discerns sit-up and chin-up).

In one example, the device 650 may capture input directly in a mobile phone web browser, such as keyboard input into a form field for sending to an electronic training system website.

The operations 918, 920, and 922 may use database 950 to look up inputs and relevant information (e.g., past performance, calories today, etc.)

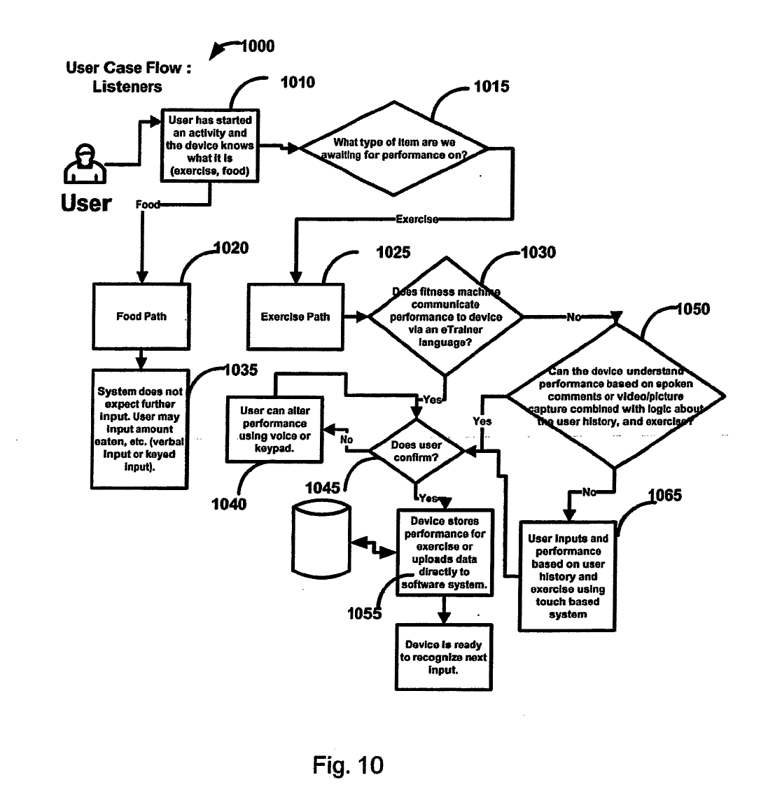

FIG. 10 is a flow chart illustrating a method 1000, according to an example embodiment, of operation of the performance listener module 690. The electronic training system 600 may move into this state after an object has been recognized were successfully identified (operation 1010). If the item recognized is a food item (food path 1020), the performance listener module 690 are not be awaiting a performance report (operation 1035). By default, it is assumed the object recognized is fully consumed. However, the user 702 may edit this, if for example, only half of the steak dinner was eaten, using the electronic training's input unit 610. If the object is an exercise item, the electronic training system 600 expects a performance report.

If at operation 1015, electronic training language is detected (for example, using a device transmitting Bluetooth 809), the exercise path 1025 is followed. The electronic training device 650 may attempt to discover performance, at decision operation 1030, by communicating directly with the fitness machine. The user may be asked to confirm (decision operation 1045) any automatic performance suggestion. The device 650 may then store performance for exercise or upload data directly to the software analysis system 619 (operation 1055). If there is no electronic training language communication, the user can use the other input options to report performance (operation 1040).

The user may speak his/her performance (or, if the device 650 is a suitably equipped with image capture capabilities, have it take motion capture of the exercise to derive performance) (decision operation 1050) or input performance data by browsing or typing it into the touch based input system (operation 1065). With each method of performance listening, the user has the option to confirm.

Note the user 702 may skip some methods of input and try others—there is no implicit required order. The method 1000 does not require that the user must try each option before moving on to the next.

The electronic training may also report some suggestions or fuzzy matching if it cannot exactly understand the performance indicated, allowing the user to select from a number of possible performances (for example, if the user mumbles 60 and the device discerns 60 and 70).

Note that this flow may take place both on the device 650 alone or on the device 650 acting as a client system in conjunction with a server system. For example, if a mobile phone web browser was used to deliver, to an electronic training website, that the object is a step machine 820, the website may return a web page including a form that asks how many steps were run, at what rate, etc.

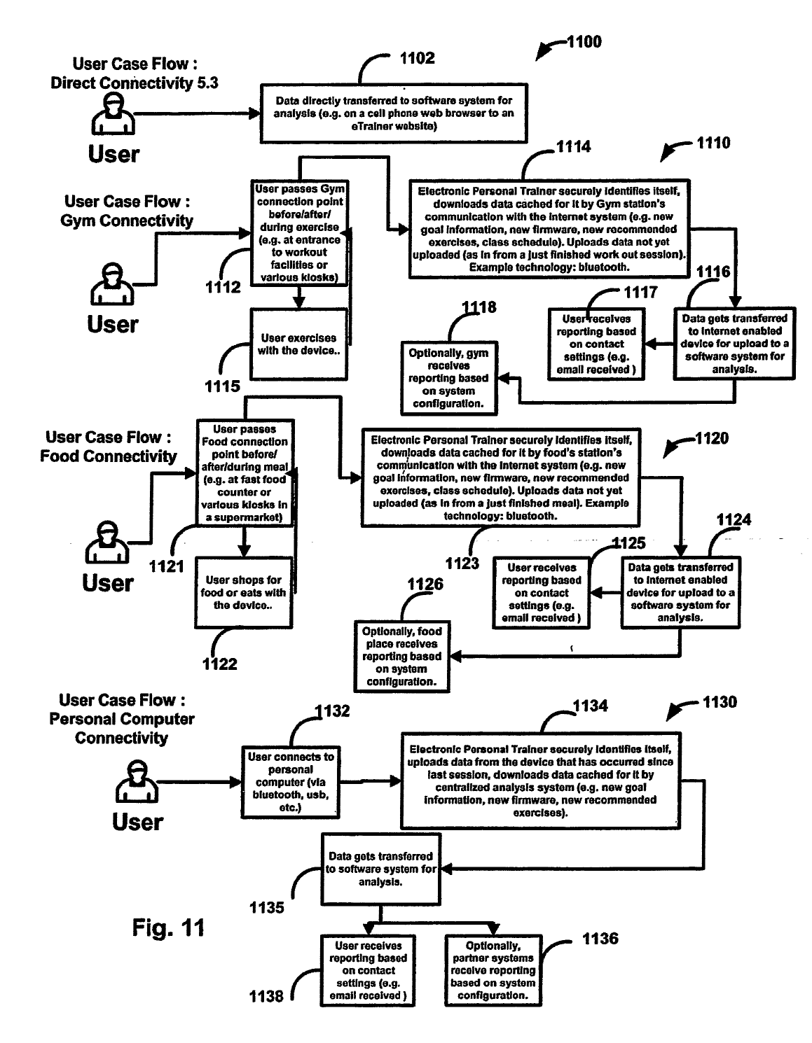

FIG. 11 is a collection of four block diagrams, showing four example embodiments of primary agent connections that may be used by the electronic training device 650 to reach the software analysis system 619 via a communications network (e.g. the Internet).

Block diagram 1100 shows an example Direct Connectivity in which the device 650 communicates directly with the software analysis system 619, via GPRS for example, sending its data to an software analysis system 619 (operation 1102). In an example embodiment, a user may use a portable device 650 (e.g. a mobile phone) to log into the electronic training web page, and access his or her account (or the device may auto-log them in via cookies, stored passwords or similar technology). After identity verification, the data is transferred to the software analysis system 619.

In another example connectivity method, Gym Connectivity 1110, the user may pass a connection point (e.g., exercise equipment 670, an agent station 618), while holding his or her electronic training device 650. Once within the active radius of a connection point (e.g., exercise equipment 670 or food station 660), the electronic training device 650 may establish a connection with the connection point (operation 1112) and identify itself. The electronic training device 650 may upload all recognized objects and performance data since a last upload (operation 1114).

The connection point (e.g., 660 or 670) may communicate this information to the software analysis system 619 for analysis (operation 1116). The connection points (e.g., 660 or 670) may also be managed by the software analysis system 619. This may be enabled by, for example, using the software analysis system 619 to push out firmware software to a connections point (e.g., 660 or 670), and then the connection point (e.g., 660 or 670) pushing it to the electronic training device 650.

The electronic training device 650 may also download any data or programming that the connection point has cached for it. This includes updates to the firmware, goal information, or additional information received by the software analysis system 619. The software analysis system 619, after receiving the updates from the electronic training device, may then send, at operation 1117, a report to the user on the user's most recent workout and dietary intake.

The software analysis system 619 may wait a period of time after the last received update from an agent in order to determine that a “workout” was completed. Such a report may be in the form of an email sent to the registered email address of the user of the electronic training system 600. Optionally, at operation 1118, a report about individual users or a group of electronic training system 600 users may be sent to the gym facility to enable them to better monitor their facilities (such as the traffic flow through the gym, who is eating what).

An example food connectivity is shown in block diagram 1120. A food connection point 660 which might be deployed in a health food supermarket may enable electronic training shoppers to enter their shopping carts (operations 1121 and 1022) into the electronic training system 600. The electronic training device 650 may identify itself; download data cached for by the food connection point 660 communication and upload data not yet uploaded (operation 1123). Then at operation 1124, data may be transferred to the electronic training device 650 and the user may receive reports and advice based on their eTraining program while still in the store (operation 1125). The supermarket may optionally receive information on the diets of their customers using such a system (operation 1126).

Block diagram 1130 shows an example personal computer connectivity mode. This connectivity mode allows the user to connect an electronic training device 650 to a personal computer 617 (operation 1132) to upload the user's electronic training data to the software analysis system 619 for immediate feedback (operation 1132). The electronic training device 650, at operation 1134, may identify itself, upload data that has been captured since a last session from the device, and download the data cached for it by software analysis system 619. The data may then be transferred to the software analysis system 619 (operation 1135), reported to the user (operation 1138), and optionally reported to the partner information system 616 (operation 1136).

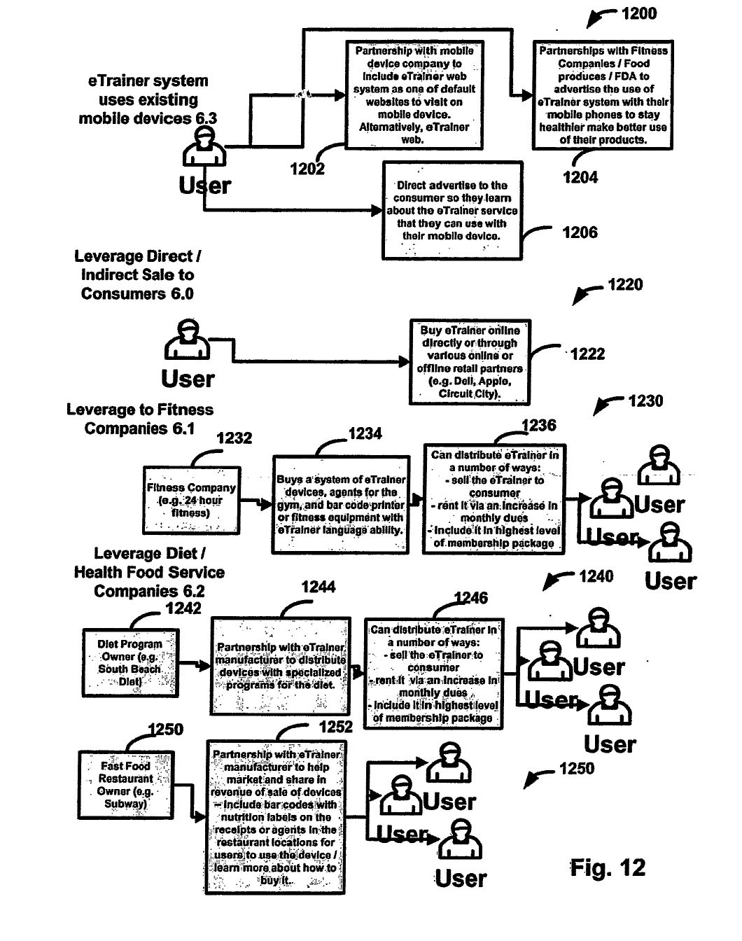

FIG. 12 is a collection of flow diagrams, describing in an example embodiment four example methods of distribution of electronic training devices 650 and other compatible devices. The actual distribution systems may vary, depending on the circumstances at the time of implementation. The first distribution model 1200 may rely on the distribution of a mobile device (e.g. 704) that is compatible with the electronic training system 600 and then marketing the software analysis system 619 to people who have the compatible mobile device or people considering purchasing the mobile device. This may be accomplished by co-marketing with the device manufacturer (operation 1202), co-marketing with fitness and health companies who benefit from increased customer satisfaction as a result of device usage (operation 1204), or direct advertising (operation 1106).

In an example embodiment 1220 using a mobile phone 704 with a barcode reader, the electronic training system 600 may be offered as a service available online leveraging direct/indirect sales to consumers, such as a service offered by a major portal, for analyzing personal health (operation 1222). The device 650 may be marketed directly to the consumer by the manufacturer or a reseller, such as a consumer electronics website selling the device to the user.

In another example embodiment, a third distribution model 1230 may be used, where the fitness companies 1232 may buy, from the manufacturer, a set of electronic training devices 650 and connection points or agent stations 618 for usage in the fitness services (operation 1234), either as products they may sell directly, rent, or include with higher levels of membership (operation 1236). The manufacturer may also include machines for the fitness companies to label their equipments (such as exercise equipment 670) with barcodes that the electronic training devices 650 may read.

According to another example embodiment, the fourth distribution model 1240 deals with food distribution channels. In one example, at operation 1244, an electronic training manufacturer may partner with a diet or a lifestyle company 1242, such as “South Beach Diet” to include an electronic training device 650 as part of its products and services (and associated dietary programs pre-installed on the device or associated analysis software) (operation 1246).

In another example, an electronic training manufacturer may partner with a food store location 1250 to co-market the product with in-store kiosks (e.g., food station 660) that may serve as connection points and information booths about the electronic training device 650 (operation 1252). Many of the aforementioned models may be mixed and matched and are not meant to represent an exhaustive list of how the electronic training system could achieve distribution.

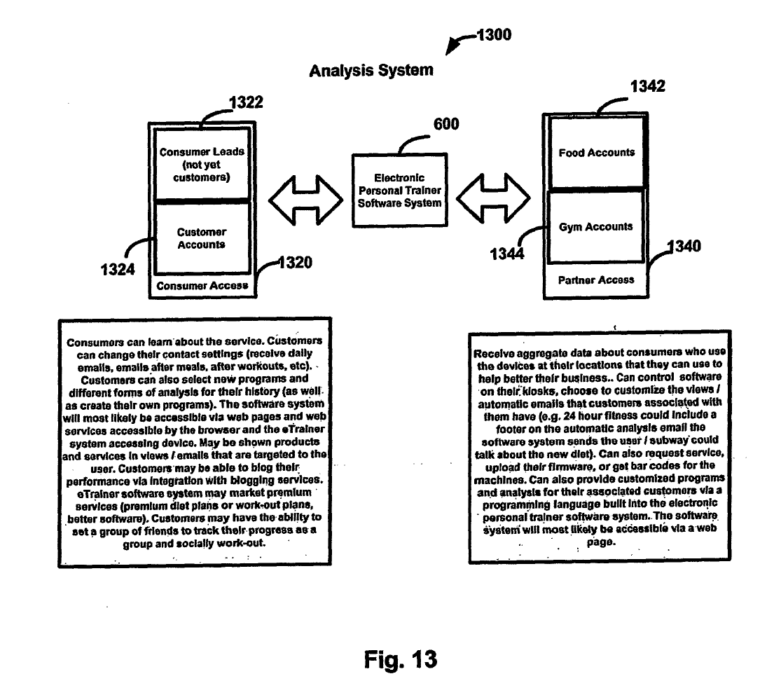

FIG. 13 is a block diagram 1300, illustrating in an example embodiment how the electronic training system 600 exchanges information with the electronic training device 650 or the agent station 618 that serve as a go-between for the electronic training devices 650. The electronic training system 600 in an example embodiment is accessible in a human readable format, such as a website, for partners operating connection points 1340 (e.g., food accounts 1342 and gym accounts 1344) and the electronic training users via the network (e.g. Internet) 615. It also may be accessible by the electronic training device 650, and user computers 617.

The electronic training system 600 may provide a more comprehensive interface for consumer access 1320 including consumer leads 1322 and customer accounts 1324. The owners of electronic training device 650 may also be able to manage their health and fitness via a website. At these web interfaces, for example, consumers may learn about the service, change their contact settings (e.g., receive daily emails, emails after meals, after workouts, etc), select new programs and different forms of analysis for their heath history (as well as create their own programs). As part of the software analysis system 619, users may be shown products and services in views/emails that are targeted to the user.

Customers may be able to blog their performance via integration with blogging services. The electronic training software analysis system 619 may market premium services (premium diet plans or work-out plans, better software). Customers may have the ability to set a group of friends to track their progress as a group and socially work-out.

In addition to managing the devices and connection points for partners 1340, partners who host the agent station 618 or distributions should be able to manage their programs from an Internet location where they are able to receive aggregate data about customer accounts 1324 who use the devices at their locations that they can use to help better their business or customer experience.

In one example embodiment, partners 1340 are able to control software on their agent station 618, choose to customize the views/automatic emails that customers associated with them have (e.g., 24 Hour Fitness may include a footer on the automatic analysis email the software analysis system 619 sends the user/subway may talk about a new diet). Partners 1340 may also request service, upload their firmware, or get barcodes for the machines. The software analysis system 619 may also provide customized programs and analysis for their associated customers via a programming language built into the electronic personal trainer software analysis system 619.

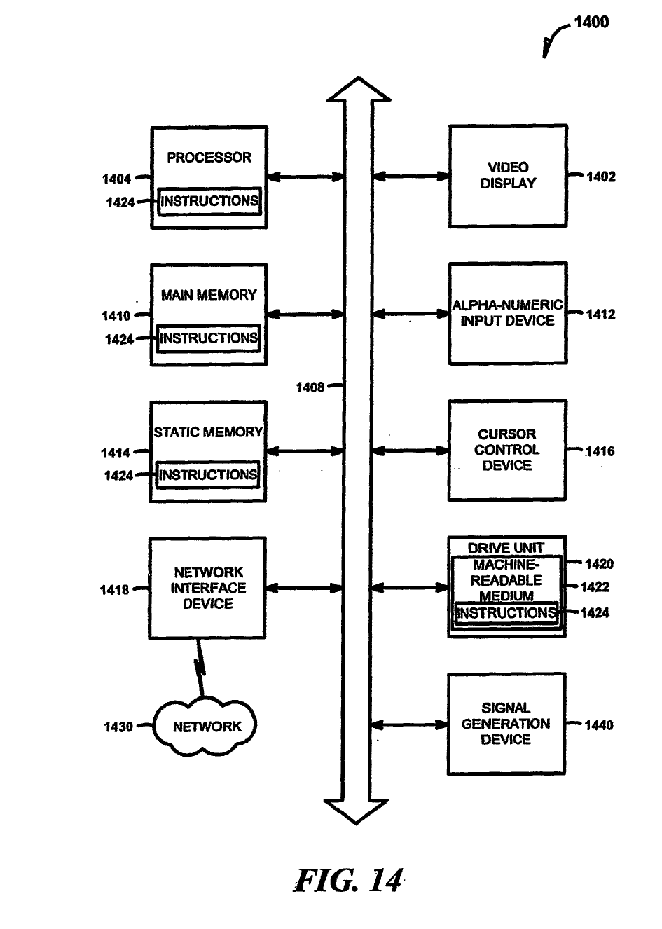

FIG. 14 is a block diagram showing a diagrammatic representation of machine in the example form of a computer system 1400 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1404 (e.g., a central processing unit (CPU) a graphics processing unit (GPU) or both), a main memory 1410 and a static memory 1414, which communicate with each other via a bus 1408. The computer system 1400 may further include a video display unit 1402 (e.g., a liquid crystal display (LCD) or a cathode ray tube (CRT)). The computer system 1400 also includes an alphanumeric input device 1412 (e.g., a keyboard), a cursor control device 1416 (e.g., a mouse), a disk drive unit 1420, a signal generation device 1440 (e.g., a speaker) and a network interface device 1418.

The disk drive unit 1420 includes a machine-readable medium 1422 on which is stored one or more sets of instructions (e.g., software 1424) embodying any one or more of the methodologies or functions described herein. The software 1424 may also reside, completely or at least partially, within the main memory 1410 and/or within the processor 1404 during execution thereof by the computer system 1400, the main memory 1410 and the processor 1404 also constituting machine-readable media.

The software 1424 may further be transmitted or received over a network 1430 via the network interface device 1418.

While the machine-readable medium 1422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
identifying, at an input device, a first object in an environment, the first object having a health-related association to a user of the input device;
responsive to the identification of the first object, invoking an interface on the input device to receive, from the first object, health-related input data, pertaining to the first object; and
receiving the health-related input data via the interface into the input device.

2. The method of claim 1, wherein the identifying of the first object includes at least one of:
using the input device to automatically identify the object, or
providing user input pertaining to the first object to the input device.

3. (canceled)

4. The method of claim 1, wherein the identification of the first object includes at least one of a group of actions, the group of actions comprising:
reading a barcode from the first object,
comparing an image of the first object with a plurality of images in a related database,
receiving an identification related input from a user, reading an RFID tag fixed on the first object, and
using voice recognition technology to recognize a human voice describing the first object.

5. The method of claim 1, wherein the first object comprises an exercise unit and the environment is a fitness center.

6. The method of claim 1, wherein the first object is a personal exercise unit of the user, or a food item.

7. (canceled)

8. The method of claim 1, wherein the input device is at least one of:
owned by the user, or
a loaner device associated with the environment, and wherein the input device identifies the user responsive to receiving an identification input from the user.

9. (canceled)

10. The method of claim 1, wherein the health-related input data is data selected from a group of health related input data comprising performance data of the user, reflecting performance of the user on an exercise unit and dietary data of a food item.

11. The method of claim 1 including:
receiving, via a network, the health-related input data, from a remote object;
processing the health-related input data, the processing including analyzing the health-related input data, updating a user health-profile, and generating a health-related output; and
communicating the health-related output to a second object.

12. The method of claim 11, wherein the remote object is an object selected from a group comprising an exercise unit, the input device, a user interface, and an agent server connected via an internal network of the environment to a plurality of exercise units in the environment.

13. The method of claim 10, wherein the health-related input data is selected from a group of data items including health-related activity, health-related history, a confirmation from the user responsive to a request to confirm, and health-related objectives of a user.

14. The method of claim 11, wherein the health-related output is a plurality of instructions to an exercise unit, the plurality of instructions to modify settings of the exercise unit in accordance with a health-objectives and past performance of a user.

15. The method of claim 11, wherein the health-related output is selected from a group of data items comprising a performance report of the user on an exercise unit, and a dietary intake of the user.

16. The method of claim 11, wherein the second object is an object selected from a group of object comprising an exercise unit, the input device, a user computer, and an agent server connected via an internal network of the environment to a plurality of exercise units in the environment.

17. A system comprising:
an identification module to identify at an input device, a first object in an environment, the first object having a health-related association to a user of the input device; and
an interface to receive health-related input data into the input device, the identification module, responsive to the identification of the first object, to invoke the interface to receive, from the first object, the health-related input data, pertaining to the first object.

18. The system of claim 17, wherein the identification module is further to automatically identify the first object.

19. The system of claim 17, wherein the identification module to identify the first object is to receive user input pertaining to the first object.

20. The system of claim 17, wherein the identification module is selected from a group comprising:
a barcode reader to read a barcode fixed to the first object,
a digital camera to capture an image of the first object and an object recognizer to recognize the first object by comparing the captured image of the first object with a stored image,
a RFID tag reader to read a tag associated with the first object, and
an optical receiver to receive an optical signature from an optical emitter associated with the first object.

21.-24. (canceled)

25. The system of claim 17 including:
a receiver to receive, via a network, health-related input data, from a remote object;
a processor to process the health-related input data, the processing including to analyze the health-related input data, to update a health-profile of a user, and to generate a health-related output; and
a transmitter to communicate the health-related output to a second object.

26. The system of claim 25, wherein the remote object is selected from a group of objects comprising an exercise unit, the input device, a user computer, and an agent server connected via the internal network of the environment to a plurality of exercise units in the environment.

27.-30. (canceled)

31. The system of claim 25, including a database to store health-related data of a user.

32. The system of claim 17, wherein the input device includes at least one of a memory to store input data, or a database of health-related data.

33. (canceled)

34. A system comprising:
means for identifying, at an input device, a first object in an environment, the first object having a health-related association to a user of the input device;
means for invoking, responsive to the identification of the first object, an interface on the input device to receive, from the first object, health-related input data, pertaining to the first object; and
means for receiving the health-related input data via the interface into the input device.

35. The system of claim 34 including:
means for receiving, via a network, health-related input data, from a remote object;
means for processing the health-related input data, including analyzing the health-related input data, updating a user health-profile, and generating a health-related output; and
means for communicating the health-related output to a second object.

36. A machine-readable medium embodying instructions, the instructions, when executed by a machine, causing the machine to:
identify a first object, at an input device, in an environment, the first object having a health-related association to a user of the input device;
responsive to the identification of the first object, to invoke the interface to receive, from the first object, health-related input data, pertaining to the first object; and
receive health-related input data into the input device via the interface,

37. The machine-readable medium of claim 36 wherein the instructions, when executed by the machine, causing the machine to:
receive, via a network, the health-related input data, from a remote object;
process the health-related input data, the processing including analyzing the health-related input data, updating a user's health-profile, and generating a health-related output; and
communicate the health-related output to a second object.

38. A method comprising:
at an input device,
identifying an object in an environment, the object having a health-related association to a user of the input device;
receiving a health-related input data pertaining to the object;
transmitting, via a network, the input data to a processing server, the processing server analyzing the input data and generating a health-related output;
receiving from the processing server, the generated output; and
displaying the output to the user.

39. The method of claim 38, wherein the identifying of the first object includes at least one of:
automatically identify the object at the input device, or
providing user input pertaining to the first object to the input device.

40. (canceled)

41. The method of claim 38, wherein the identification of the object includes at least one of a group of actions, the group of actions comprising:
reading a barcode from the object and communicating the barcode data to the processing server,
capturing an image of the object and transmitting the image to the processing server and recognizing the object at the processing server by comparing the image of the object with an image in a related database,
reading an RFID tag fixed on the object and communicating the tag data to the processing server,
receiving an identity related input from a user and communicating the input to the processing server, and
recording a human voice describing the object, communicating the recorded voice to the processing server and using voice recognition technology to recognize the human voice describing the object.

42. The method of claim 38, wherein the receiving health-related input data includes at least one of a group of actions, the group of actions comprising:
wireless RF communication between the input device and an exercise unit,
recording a human voice reading the data into the input device,
receiving the data from a user interface in the input device, and
optical communication between the input device and an exercise unit.

43. The method of claim 38, wherein the received health-related input data includes at least one of a group of items, the group of items comprising:
a dietary intake of the user,
a health-related activities of the user, and
a confirmation by the user responsive to a request to confirm.

44. The method of claim 38, wherein the health-related output is at least one of a group of items, the group of items comprising:
a health related performance report of the user on a plurality of exercise units,
a plurality of health related instruction for the user to follow,
a dietary intake of the user and
a dietary recommendation to the user.

45. The method of claim 38, wherein the input device obtained by the user in at least one of a group of methods, the group of methods comprising:
purchased from a vendor,
purchased from the environment, and
loaned by the environment, wherein the input device identifies the user responsive to receiving an identification input from the user.

46. An input device comprising:
an identification module to identify an object in an environment, the object having
a health-related association to a user of the input device;
a receiver module to receive, from the object, health-related input data associated with a user;
a transmitter module to transmit, via a network, the health-related input data to a processing server, the processing server to analyze the input data, to generate a plurality of health-related outputs, and to communicate the outputs to the receiver; and
a display module to display the outputs received from the processing server by the receiver and delivered to the display module.

47. The input device of claim 46, wherein the identification module further to automatically identify the first object by receiving user input pertaining to the first object.

48. (canceled)

49. The input device of claim 46 including a user interface module to receive, from the user, personal health-related input data associated with the user;

50. The input device of claim 46, wherein the identification module is at least one of a group of modules, the group of modules comprising:
a digital camera, wherein the identification signature is an image of the object captured by the camera,
a barcode reader, wherein the identification signature is a barcode on the object,
a voice recorder, wherein the identification signature is a human voice describing the object,
a RFID reader, wherein, the identification signature is data stored on an RFID tag fixed to the object, and
an optical receiver, wherein, the identification signature is an optical data transmitted from an optical transmitter fixed to the object.

51. The input device of claim 50, wherein the identification module includes a separate device capable of processing data and communicating with the input device.

52.-53. (canceled)

54. The input device of claim 46, wherein the personal health-related input data is at least one of a group of items, the group of items comprising:
a confirmation by the user in response to a request to confirm,
a description of an exercise unit,
a dietary intake of the user, and
health-related objectives, health-related activities, and health-related performances of the user.

55. The input device of claim 46, wherein the health-related output data is at least one of a group of items, the group of items comprising:
a plurality of instructions for the user to follow.
a dietary intake of the user, and
health-related objectives, health-related activities, and health-related performances of the user.

56. The input device of claim 46, wherein the input device includes at least one of a group of modules, the group of modules comprising a memory to store input data and a database of health-related data.

57. The input device of claim 46, wherein the input device communicates health-related data to a user computer, the user computer, responsive to receiving the data, communicates the data to the processing server.

58. An input device comprising:
means for identifying an object in an environment, the object having a health-related association to a user of the input device;
means for receiving health-related input data pertaining to the object;
means for transmitting the input data to a processing server, the processing server analyzing the input data and generating a health-related outputs;
means for receiving from the processing server, the generated output; and
means for displaying the output to the user.

59. A machine-readable medium embodying instructions, the instructions, when executed by a machine, causing the machine to:
to identify an object in an environment, the object having a health-related association to a user of the input device;
to receive, from the object, health-related input data associated with a user;
to transmit the health-related input data to a processing server, the processing server to analyze the input data, to generate health-related outputs, and to communicate the outputs to the receiver; and
to display the outputs received from the processing server by the receiver and delivered to the display module.
